(19) United States
(12) Patent Application Publication
(10) Pub. No.: US 2014/0147554 A1
(43) Pub. Date: May 29, 2014

(54) ENZYME BEVERAGE OF NATURAL GARDEN STUFF AND METHOD FOR PREPARING THE SAME

(71) Applicant: CHINA NATIONAL RESEARCH INSTITUTE OF FOOD AND FERMENTATION INDUSTRIES, Beijing (CN)

(72) Inventors: Muyi Cai, Beijing (CN); Ruizeng Gu, Beijing (CN); Jun Lu, Beijing (CN); Weixue Yi, Beijing (CN); Zhe Dong, Beijing (CN); Yong Ma, Beijing (CN); Xingchang Pan, Beijing (CN); Yaguang Xu, Beijing (CN); Yongqing Ma, Beijing (CN); Feng Lin, Beijing (CN); Zhentao Jin, Beijing (CN); Wenying Liu, Beijing (CN); Liang Chen, Beijing (CN); Lu Lu, Beijing (CN)

(73) Assignee: CHINA NATIONAL RESEARCH INSTITUTE OF FOOD AND FERMENTATION INDUSTRIES, Beijing (CN)

(21) Appl. No.: 14/166,643

(22) Filed: Jan. 28, 2014

Related U.S. Application Data
(63) Continuation of application No. PCT/CN2012/081021, filed on Sep. 5, 2012.

(30) Foreign Application Priority Data
Sep. 7, 2011 (CN) 201110263097.1

(51) Int. Cl. A23L 2/02; A23L 2/66

(52) U.S. Cl. CPC A23L 2/02; A23L 2/66
USPC 426/51; 426/599

(57) ABSTRACT

The present invention discloses an enzyme beverage of natural garden stuff and a method for preparing the same. The enzyme beverage is prepared from a fresh juice extracted from fresh garden stuffs and added with marine fish-skin collagen peptide, as a fermentation substrate, by dilution, blending and sterilization followed by stepwise fermentation with lactobacillus and yeast in sequence. With stepwise fermentation of the garden stuff juice from two or more fresh garden stuffs with lactobacillus and yeast, and the addition of marine fish-skin collagen peptide for accelerating growth and metabolism of fermenting strains, said beverage contains more abundant metabolites from the nutritional ingredients of the natural garden stuffs, and will bring more beneficial and nutritional effects on health.

### CROSS-REFERENCE TO RELATED APPLICATIONS

This application is a continuation of the international application No. PCT/CN2012/081021 filed on Sep. 5, 2012, which claims the priority benefits of Chinese application No. 201110263097.1 filed on Sep. 7, 2011. The contents of those prior applications are hereby incorporated by reference in their entireties.

### FIELD OF THE TECHNOLOGY

This invention relates to an enzyme beverage of natural garden stuff, and a method for preparing the same, and particularly, to a technology of preparing a fermented beverage of natural garden stuff with lactobacillus and yeast through stepwise fermentation, belonging to the field of food and beverage technology.

### BACKGROUND

Fruit and vegetable juice beverages are characterized by their delicious taste and rich nutrients, and contain natural antioxidants that can eliminate harmful “free radicals” in human body. However, quality and flavor of normal garden stuff juice beverages will change with the storage time, and thus preservatives, antioxidants and stabilizers need to be added. Enzyme beverages made by microbial fermentation will not only enhance stability of the garden stuff juice, eliminating the harm to human body caused by the addition of the preservatives, but also produce a variety of flavor substances, improve nutritional value and help digestion and absorption while retaining the original nutrients of the garden stuff juice.

The process for preparing enzyme beverage by microbial fermentation of garden stuff juice can promote metabolic reactions of carbohydrates, proteins, lipids, and the like in garden stuff, produce and accumulate a large number of primary and secondary metabolism products, and generate a variety of beneficial ingredients such as organic acid, oligosaccharide, sugar alcohol, enzymes, oligopeptide, and polyphenol; meanwhile, the resulting enzyme beverage also contains nutritional and functional ingredients originally contained in the garden stuff and microbe themselves. These beneficial ingredients can promote the proliferation of beneficial intestinal bacteria, and suppress propagation of harmful bacteria and formation of corruption substances, thus producing a variety of beneficial effects on human, such as regulating the balance of intestinal flora, enhancing immunity, promoting sleep, delaying aging, etc. Thus, the enzyme beverages prepared from natural garden stuff, due to their nutrition and health function and unique flavor, are widely favored by customers.

Currently, enzyme beverages, or fermented beverages of garden stuff juice mostly adopts single step fermentation with a single strain or composite strains. For example, Chinese patent application CN200410045421.2 discloses a composite garden stuff juice beverage made by single step fermentation with mixture of Lactobacillus plantarum and Streptococcus cremoris, and a preparation method thereof. Chinese patent applications CN200810042081.6 discloses a method for preparing a vegetable juice beverage by single step fermentation with mixture of Lactobacillus plantarum and Lactobacillus bulgaricus.

The present invention provides a method for stepwise fermentation of natural garden stuff with lactobacillus and yeast, which is able to make the fermentation process more sufficient, the metabolism of nutrients contained in the natural garden stuff more complete, and produce more flavor substances and nutrients.

### SUMMARY

The present invention provides an enzyme beverage of natural garden stuff, wherein the enzyme beverage is prepared by stepwise fermentation of a garden stuff mixture juice by means of respectively inoculating lactobacillus and yeast into the mixture juice, and by taking advantage of active substances originating from natural garden stuff mixture and metabolites produced by fermentation of lactobacillus and yeast, the enzyme beverage prepared is delicious and contains nutrients beneficial to human body, having both nutritional function and healthy function. Also, the present invention provides a method for preparing the enzyme beverage.

The present invention provides an enzyme beverage of natural garden stuff, where the enzyme beverage is prepared by stepwise fermentation of a fermentation substrate with lactobacillus and yeast, wherein the fermentation substrate contains a garden stuff pulp and marine fish-skin collagen peptide powder, the garden stuff pulp is prepared by juicing at least two or more kinds of the garden stuff and blending them.

According to embodiments of the invention, the fermentation substrate contains a garden stuff pulp and marine fish-skin collagen peptide powder, the garden stuff pulp is prepared by juicing at least two or more kinds of the garden stuff, and one or more kinds of edible fungi and marine algae, and blending them.

In the enzyme beverage of the invention, the marine fish-skin collagen peptide powder has an average molecular weight of less than 1000.

The enzyme beverage according to an embodiment of the invention can be prepared by a method comprising the following steps:

(1) preparing a fermentation substrate: juicing at least two kinds of garden stuff with basically the same weight ratio and mixing them to form a garden stuff juice, diluting the juice with basically the same volume of purified water, to form a garden stuff pulp, adding 2˜3% (w/v) of marine fish-skin collagen peptide powder into the pulp, and then high temperature sterilizing and cooling;

(2) fermenting with lactobacillus: based on the fermentation substrate, adding 2˜4 U/1000 L of lactic starter strains into the fermentation substrate, the fermentation is performed at a temperature of 30˜35° C. and ended when pH reaches 4.3, to form a lactobacillus fermented liquid;

(3) fermenting with yeast: adding sucrose and 1.0˜1.5% (w/v) of the marine fish-skin collagen peptide powder into the lactobacillus fermented liquid, high temperature sterilizing and cooling, and then adding 0.08˜0.12% (w/v) of a high active dry yeast, the fermentation is performed at a temperature of 25˜30° C. and ended when pH reaches 4.0, followed by sterilizing the resulting fermented product at a high temperature and cooling it, to form a yeast fermented liquid; and

(4) homogenizing, concentrating, and blending: homogenizing, concentrating, and blending the yeast fermented liquid, to obtain the enzyme beverage.

In the above method for preparing the enzyme beverage, the yeast fermented liquid can be first homogenized and concentrated to 10 Brix and then subject to centrifugation and filtration. In the resulting filtrate, 0.5˜1.0% of maltitol, 0.1˜0.2% of galactooligosaccharide, and 0.01˜0.02% of acesulfame, based on weight of the filtrate, are added, followed by filtrating and sterilizing again.

An embodiment of the present invention also provides a method for preparing an enzyme beverage of natural garden stuff, comprising the following steps:

(1) preparing a fermentation substrate: juicing, after washing and cutting, two or more kinds of fresh garden stuff with basically the same weight ratio (including one or more kinds of edible fungi and marine algae, besides common vegetables and fruits) and blending them to form a garden stuff juice, diluting the juice with basically the same volume of purified water, to form a garden stuff pulp, adding 2˜3% (w/v) of marine fish-skin collagen peptide powder into the pulp, and then high temperature sterilizing in a fermenter and cooling the resulting mixture;

(2) fermenting with lactobacillus: adding 2˜4 U/1000 L of lactic starter strains into a fermentation substrate, the fermentation is performed at a temperature of 30˜35° C. and ended when pH reaches 4.3 (generally 7-11 days), to form a lactobacillus fermented liquid;

(3) fermenting with yeast: adding an appropriate amount of sucrose (e.g., 1˜1.5% (w/v), as a supplement to the fermentation substrate) and 1˜1.5% (w/v) of marine fish-skin collagen peptide powder into the lactobacillus fermented liquid, high temperature sterilizing and cooling the resulting mixture, and then adding 0.08˜0.12% (w/v) of a high active dry yeast, the fermentation is performed at a temperature of 25˜30° C. and ended when pH reaches 4.0 (generally 5-7 days), followed by high temperature sterilizing and cooling, to form a yeast fermented liquid, and then storing it in a tank at 8˜12° C. for 14˜21 days; and

(4) homogenizing, concentrating, and blending: homogenizing the yeast fermented liquid for 10˜15 min at 40 MPa; concentrating to about 10 Brix by, for example, a double-effect-and-low temperature concentrator at 60˜80° C.; centrifuging for 15˜25 min at 2500˜3500 rpm; filtrating by, for example, an organic membrane microfiltration filter; adding a sweetness in the resulting filtrate and blending; and then filtrating and pasteurizing, to obtain the enzyme beverage.

In order to meet the needs of various groups of people and reduce the intake of sucrose, a sweetener can be used for blending into the end product. In a preferred embodiment, 0.5˜1.0% of maltitol, 0.1˜0.2% of galactooligosaccharide, and 0.01˜0.02% of acesulfame are added into the filtrate, and then an organic membrane microfiltration filter, for example, is used for filtration, and a sterilization treatment is followed.

The enzyme beverage of the invention can be filled and sealed according to oral liquid production process, and sterilized by pasteurization, to prepare a beverage product in the form of oral liquid, which is to be stored at a low temperature of 4˜10° C.

In the present invention, the lactic starter strains may be commercially available direct vat set (freeze-dried) lactic starter strains.

In the present invention, the fresh garden stuff as raw materials can be any fruit and vegetable. Appropriate fruits and vegetables can be chosen to match and mix with each other according to different preferences, the taste and function requirements of the people, or their supply situation of production areas. Of course, synthetically considering the nutrition and the taste, it is preferred to choose a combination of fruits with vegetables, and the fruits or the vegetables preferably are combinations of different types of fruits or vegetables, respectively. Additionally, the edible fungi and the marine algae are not particularly limited, and can be chosen according to preferences, taste and function requirements of the people. Thus the following examples only exemplarily list some raw materials to illustrate the embodiments of the invention, but not limit the raw materials of the invention, and they can be adjusted regarding matches and combination.

In the present invention, the term “garden stuff juice” refers to the product obtained by directly juicing garden stuff as raw material and without further filtration treatment. Thus, the product obtained may contain garden stuff fibers. When the raw material contains edible fungi and marine algae, the product obtained by juicing them also belong to the garden stuff juice.

The method according to the invention, in the step of preparing the fermentation substrate, may further comprise juicing one or more kinds of edible fungi and marine algae, and then mixing them with the garden stuff juice.

The marine fish-skin collagen peptide powder as described in steps (1) and (3) has an average molecular weight of less than 1000.

The marine fish-skin collagen peptide powder as used herein, which is also referred to fish-skin collagen oligopeptide, can be a powder product obtained by pre-treatment, enzymolysis, separation, purification and drying of deep-sea salmon skin as raw material from high latitude regions, with an oligopeptide (a short peptide) with molecular weight less than 1000 as its main ingredient. The marine fish-skin collagen peptide has a protein content of not less than 90%, excellent solubility in water, acid-base stability, and can be completely dissolved even under acidic conditions, and good processing properties such as good emulsifying and foaming properties. It also has nutrition and health functions as bioactive peptide. The marine fish-skin collagen peptide, due to high digestion and absorption ratio, is mainly used for food fortification and as amino acid balance supplement agent. Additionally, the marine fish-skin collagen peptide is rich in nutrients and has unique moisturizing property, so that it can bring moist, smooth and elastic to skin, and also can externally protect the skin from the sun damage and internally protect the skin from free radical damage. Using the marine fish-skin collagen peptide as one of nitrogen supplements, in the fermentation process for preparing garden stuff beverage, is an innovation of the invention and can well promote the growth and metabolism of the lactobacillus and the yeast. Meanwhile, the marine fish-skin collagen peptide also enhances nutritional and functional properties of the fermented garden stuff juice product due to its own nutrition and health functions.

The marine fish-skin collagen peptide powder of the invention is a commercially available product, some of which are also called as oligopeptide powder of marine fish, complying with national standards, oligopeptide powder of marine fish in accordance with GB/T 22729-2008.

It can be seen from the above, the present invention provides an enzyme beverage having health function, and the beverage not only is delicious but can prevent diseases, having both nutritional function and healthy function.

### BRIEF DESCRIPTION OF THE DRAWINGS

Attached FIGURE is a flow diagram of the preparation process according to an embodiment of the present invention.

### DETAILED DESCRIPTION

The present invention will be further illustrated according to the following embodiments, but not limited to these embodiments. These embodiments are not intended to limit the scope of the invention in any way. Various changes and modifications may be made to the present invention by the skilled in the art within the scope of the appended claims, and these also shall be considered as falling within the scope of the invention.

### Embodiment 1

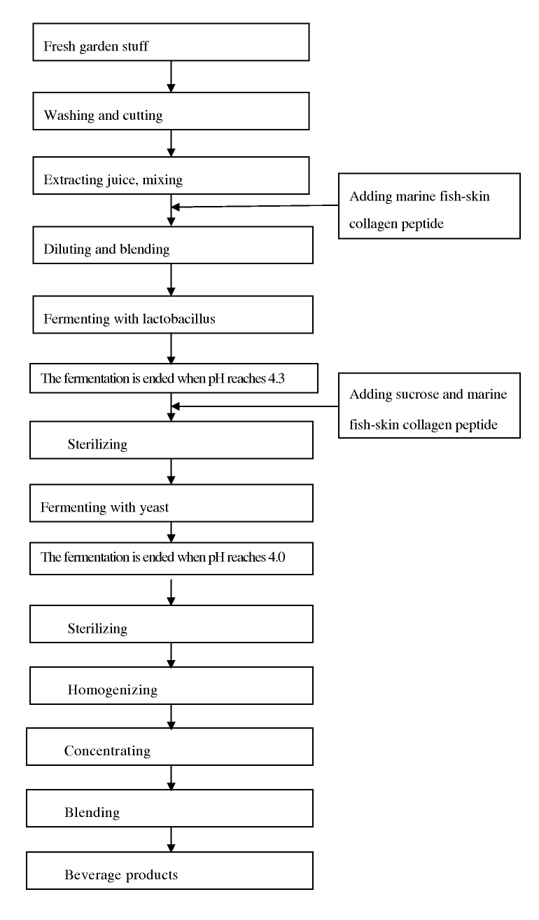

The process is as shown in FIG. 1. Fresh white apple, pineapple, red grape, dosui pear, tomato, cabbage, celery, and cucumber are each taken in an amount of 1 kg, washed, cut into pieces, and juiced. After mixing, the resulting garden stuff juice is diluted and blended with the same volume of purified water, to obtain a garden stuff pulp. Then 2% (w/v) of marine fish-skin collagen peptide powder is added into the garden stuff pulp, and the resulting mixture is sterilized at a high temperature and cooled. 2 U/1000 L of direct vat set (freeze-dried) lactic starter strains are added, the fermentation is performed for 7 days at 30° C. and ended until pH is 4.3, to form a lactobacillus fermented liquid. 1% of sucrose (w/v) and 1% (w/v) of marine fish-skin collagen peptide powder are added into the lactobacillus fermented liquid. The resulting mixture is sterilized at a high temperature and cooled, and then 0.08% of high active dry yeast is added into it, the fermentation is performed for about 5 days at 25° C. and ended when pH reaches 4.0. The resulting product is sterilized at a high temperature and cooled, and then stored in a tank at 8° C. for about 15 days.

The fermented liquid obtained as above is homogenized for 10 min at 40 MPa; concentrated to 10 Brix by a double-effect-and-low temperature concentrator at 60° C. under vacuum; centrifuged for 25 min at 2500 rpm; and filtrated by an organic membrane microfiltration filter. Then 1.0% of maltitol, 0.1% of galactooligosaccharide, and 0.01% of acesulfame (based on the weight of the filtrate; the same as below) are added into the resulting filtrate. The resulting mixture is again filtrated by the organic membrane microfiltration filter, and filled, sealed according to oral liquid production process, and then sterilized by pasteurization, to obtain a bottled beverage product in the form of oral liquid, which is to be stored at a low temperature of 4° C.

### Embodiment 2

Fresh red apple, watermelon, blueberry, lemon, green pepper, wax gourd, asparagus, and sea lettuce are each taken in an amount of 5 kg, washed, cut into pieces, and juiced. After mixing, the resulting garden stuff juice is diluted and blended with basically the same volume of purified water, to obtain a garden stuff pulp. Then 2.5% (w/v) of marine fish-skin collagen peptide powder is added into the garden stuff pulp, and the resulting mixture is sterilized at a high temperature and cooled. 3 U/1000 L of direct vat set (freeze-dried) lactic starter strains are added, the fermentation is performed for 10 days at 35° C. and ended until pH is 4.3, to form a lactobacillus fermented liquid. 1.2% of sucrose (w/v) and 1.2% (w/v) of marine fish-skin collagen peptide powder are added into the lactobacillus fermented liquid. The resulting mixture is sterilized at a high temperature and cooled, and then 0.10% of high active dry yeast is added into it, the fermentation is performed for about 6 days at 28° C. and ended when pH reaches 4.0. The resulting product is sterilized at a high temperature and cooled, and then is stored in a tank at 10° C. for about 18 days.

The fermented liquid obtained as above is homogenized for 12 min at 40 MPa; concentrated to 10 Brix by a double-effect-and-low temperature concentrator at 70° C. under vacuum; centrifuged for 15 min at 3500 rpm; and filtrated by an organic membrane microfiltration filter. Then 0.5% of maltitol, 0.2% of galactooligosaccharide, and 0.01% of acesulfame are added into the resulting filtrate. The resulting mixture is again filtrated by the organic membrane microfiltration filter, and filled, sealed according to oral liquid production process, and then sterilized by pasteurization, to obtain a bottled beverage product in the form of oral liquid, which is to be stored at a low temperature of 4° C.

### Example 3

Fresh kiwi, Hami melon, navel orange, Brown plum, white radish, zucchini, flat mushroom, and needle mushroom are each taken in an amount of 10 kg, washed, cut into pieces, and juiced. After mixing, the resulting garden stuff juice is diluted and blended with basically the same volume of purified water, to obtain a garden stuff pulp. Then 2% (w/v) of marine fish-skin collagen peptide powder is added into the garden stuff pulp, and the resulting mixture is sterilized at a high temperature and cooled. 4 U/1000 L of direct vat set (freeze-dried) lactic starter strains are added, the fermentation is performed for 10 days at 35° C. and ended until pH is 4.3, to form a lactobacillus fermented liquid. 1.5% of sucrose (w/v) and 1.5% (w/v) of marine fish-skin collagen peptide powder are added into the lactobacillus fermented liquid. The resulting mixture is sterilized at a high temperature and cooled, and then 0.12% of high active dry yeast is added into it, the fermentation is performed for about 7 days at 30° C. and ended when pH reaches 4.0. The resulting product is sterilized at a high temperature and cooled, and then stored in a tank at 12° C. for about 20 days.

The fermented liquid obtained as above is homogenized for 15 min at 40 MPa; concentrated to 10 Brix by a double-effect-and-low temperature concentrator at 80° C. under vacuum; centrifuged for 20 min at 3000 rpm; and filtrated by an organic membrane microfiltration filter. Then 0.5% of maltitol, 0.1% of galactooligosaccharide, and 0.02% of acesulfame are added into the resulting filtrate. The resulting mixture is again filtrated by the organic membrane microfiltration filter, and filled, sealed according to oral liquid production process, and then sterilized by pasteurization, to obtain a bottled beverage product in the form of oral liquid, which is to be stored at a low temperature of 10° C.

What is claimed is:

1. An enzyme beverage of natural garden stuff, wherein the enzyme beverage is prepared by stepwise fermentation of a fermentation substrate with lactobacillus and yeast, the fermentation substrate contains a garden stuff pulp and marine fish-skin collagen peptide powder, the garden stuff pulp is prepared by juicing at least two or more kinds of the garden stuff and blending them.

2. The enzyme beverage according to claim 1, wherein the fermentation substrate contains a garden stuff pulp and the marine fish-skin collagen peptide powder, the garden stuff pulp is prepared by juicing at least two or more kinds of the garden stuff, and one or more kinds of edible fungi and marine algae, and blending them.

3. The enzyme beverage according to claim 1, wherein the marine fish-skin collagen peptide powder has an average molecular weight of less than 1000.

4. The enzyme beverage according to claim 2, wherein the marine fish-skin collagen peptide powder has an average molecular weight of less than 1000.

5. The enzyme beverage according to claim 1, where the enzyme beverage is prepared by a method comprising the following steps:
(1) preparing a fermentation substrate: juicing at least two kinds of garden stuff with basically the same weight ratio and blending them to form a garden stuff juice, diluting the garden stuff juice with basically the same volume of purified water, to form a garden stuff pulp, adding 2˜3% (w/v) of the marine fish-skin collagen peptide powder into the pulp, and then high temperature sterilizing and cooling;
(2) fermenting with lactobacillus: based on the fermentation substrate, adding 2˜4 U/1000 L of lactic starter strains into the fermentation substrate, the fermentation is performed at a temperature of 30˜35° C. and ended when pH reaches 4.3, to form a lactobacillus fermented liquid;
(3) fermenting with yeast: adding sucrose and 1.0˜1.5% (w/v) of the marine fish-skin collagen peptide powder into the lactobacillus fermented liquid, high temperature sterilizing and cooling, and then adding 0.08˜0.12% (w/v) of a high active dry yeast, the fermentation is performed at a temperature of 25˜30° C. and ended when pH reaches 4.0, followed by sterilizing the resulting fermented product at a high temperature and cooling it, to form a yeast fermented liquid; and
(4) homogenizing, concentrating, and blending: homogenizing, concentrating, and blending the yeast fermented liquid, to obtain the enzyme beverage.

6. The enzyme beverage according to claim 5, where the method further comprises the following steps:
centrifuging and filtrating the yeast fermented liquid, after homogenizing and concentrating to 10 Brix, adding a sweetener in the resulting filtrate and blending, and then filtrating and sterilizing.

7. The enzyme beverage according to claim 5, where the method further comprises the following steps:
adding 0.5˜1.0% of maltitol, 0.1˜0.2% of galactooligosaccharide, and 0.01˜0.02% of acesulfame into the filtrate, based on weight of the filtrate, and blending them, followed by filtrating and sterilizing again.

8. The enzyme beverage according to claim 6, where the method further comprises the following steps:
adding 0.5˜1.0% of maltitol, 0.1˜0.2% of galactooligosaccharide, and 0.01˜0.02% of acesulfame into the filtrate, based on weight of the filtrate, and blending them, followed by filtrating and sterilizing again.

9. A method for preparing enzyme beverage of natural garden stuff, comprising the following steps:
(1) preparing a fermentation substrate: juicing, after washing and cutting, two or more kinds of fresh garden stuff with basically the same weight ratio and blending them to form a garden stuff juice, diluting the juice with basically the same volume of purified water, to form a garden stuff pulp, adding 2˜3% (w/v) of marine fish-skin collagen peptide powder into the pulp, and then high temperature sterilizing in a fermenter and cooling the resulting mixture;
(2) fermenting with lactobacillus: adding 2˜4 U/1000 L of lactic starter strains into the fermentation substrate, the fermentation is performed at a temperature of 30˜35° C. and ended when pH reaches 4.3, to form a lactobacillus fermented liquid;
(3) fermenting with yeast: adding an appropriate amount of sucrose and 1.0˜1.5% (w/v) of marine fish-skin collagen peptide powder into the lactobacillus fermented liquid, high temperature sterilizing and cooling the resulting mixture, and then adding 0.08˜0.12% (w/v) of a high active dry yeast, the fermentation is performed at a temperature of 25˜30° C. and ended when pH reaches 4.0, followed by high temperature sterilizing and cooling, to form a yeast fermented liquid, and then storing it at 8˜12° C. for 14˜21 days; and
(4) homogenizing, concentrating, and blending: homogenizing the yeast fermented liquid for 10˜15 min at 40 MPa, and then concentrating to 10 Brix at 60˜80° C.; centrifuging for 15˜25 min at 2500˜3500 rpm, and filtrating; adding a sweetener in the resulting filtrate and blending, and then filtrating and pasteurizing, to obtain the enzyme beverage.

10. The method according to claim 9, wherein before the steps of filtrating and pasteurizing, 0.5˜1.0% of maltitol, 0.1˜0.2% of galactooligosaccharide, and 0.01˜0.02% of acesulfame are added into the filtrate, to obtain the enzyme beverage.

11. The method according to claim 9, wherein the step of preparing the fermentation substrate further comprises juicing one or more kinds of edible fungi and marine algae, which have basically the same weight ratio as the fresh garden stuff, and then mixing them with the garden stuff juice.

12. The method according to claim 9, wherein the marine fish-skin collagen peptide powder used in steps (1) and (3) has an average molecular weight of less than 1000.
